(19) United States
(12) Patent Application Publication
(10) Pub. No.: US 2019/0001577 A1
(43) Pub. Date: Jan. 3, 2019

(54) MEASUREMENT, DIMENSIONAL CONTROL AND TREATMENT OF A FILAMENT

(71) Applicant: SABIC GLOBAL TECHNOLOGIES B.V., BERGEN OP ZOOM (NL)

(72) Inventor: Thomas Hocker, Pittsfield, MA (US)

(21) Appl. No.: 16/064,800

(22) PCT Filed: Dec. 28, 2016
(86) PCT No.: PCT/US2016/068793

§ 371 Date: Jun. 21, 2018

Related U.S. Application Data
(60) Provisional application No. 62/272,960, filed on Dec. 30, 2015.

(51) Int. Cl. B29C 64/393; B33Y 10/00; B33Y 50/02; B33Y 70/00; B29C 64/118

(52) U.S. Cl. CPC B29C 64/393; B33Y 10/00; B29C 64/118; B33Y 70/00; B33Y 50/02

(57) ABSTRACT

Disclosed is a method to determine a dimension of a filament in a material extrusion additive manufacturing process, the method including: illuminating a moving filament with an optical LED light source emitting light with a wavelength between 495 and 570 nanometers; detecting an output value corresponding to an edge of the moving filament at specific points with a CMOS sensor; and processing the output value in a signal processor to determine the dimension of the filament at specific points, then passing the filament through an extrusion head, and then depositing a plurality of layers of extruded filament material in a preset pattern and fusing the plurality of layers of extruded filament material to form a three dimensional article.

### BACKGROUND

Additive manufacturing (also known in the art as “three-dimensional” or “3D” printing) is a process for the manufacture of three-dimensional objects by formation of a plurality of fused layers. One method of additive manufacturing is a material extrusion-based system using a filament as feedstock, In this process, a filament (usually made from a polymer or a wax material) is fed into and melted in an extrusion head. The extrusion head, which includes a liquefier and a dispensing nozzle, receives the filament, melts the filament in the liquefier, and extrudes molten building material from the nozzle. Then the incited building material leaving the dispensing nozzle is used to create a plurality of fused layers in a three-dimensional object. A consistent diameter filament is desirable in a material extrusion-based additive manufacturing process because variations in diameter of the filament will create variations in the volume, of the material deposited as a layer in the part to be made by that additive manufacturing process. Unwanted variations in the diameter of the filament fed into the extrusion head can adversely affect characteristics of objects prepared using the additive manufacturing process. For example, if the diameter of the filament changes during the process, the object may include voids or have portions with excess material. While methods to dimensionally control these filaments have been disclosed, there is a still need in the art for more accurate methods to measure, or, optionally, better methods to dimensionally control the diameter of the filament, or treat the filament that will be used in an extrusion-based. additive manufacturing process, or both.

### SUMMARY

Disclosed herein is a method to determine a dimension of a filament in a material extrusion-type additive manufacturing process, the method including: illuminating a moving filament with an optical LED light source emitting light with a wavelength between 495 and 570 nanometers; detecting an output value corresponding to an edge of the moving filament at specific points with a CMOS sensor; and processing the output value in a signal processor to determine the dimension of the filament at specific points, then passing the filament through an extrusion head, and then depositing a plurality of layers of extruded filament material in a preset pattern and fusing the plurality of layers of extruded filament material to form a three dimensional article.

Also disclosed herein is a filament useful a material extrusion-type additive manufacturing process, the filament having at least one dimension that has been dimensionally controlled or treated by a process wherein an optical device determines a dimension of the filament, the optical device comprising: an optical LED light source with a wavelength of emitted light between 495 and 570 nanometers to emit light onto the filament; a CMOS sensor to generate an output value; and a signal processor connected to the CMOS sensor to process the output value from the CMOS sensor.

The above described and other features are exemplified by the following figures and detailed description.

### BRIEF DESCRIPTION OF THE DRAWINGS

Refer now to the figures, which are exemplary embodiments, and wherein the like elements are numbered alike.

FIG. 1 is a flow chart illustrating a method of measuring the diameter of a filament feedstock for an extrusion-based additive manufacturing process.

FIG. 2 is a flow chart illustrating a method of dimensionally controlling the diameter of a filament feedstock for an extrusion-based additive manufacturing process.

FIG. 3 is a flow chart illustrating a method of treating a filament feedstock for an extrusion-based additive manufacturing process.

### DETAILED DESCRIPTION

Disclosed herein are methods for measuring the diameter of filaments used in material extrusion-type of additive manufacturing methods based on melt extrusion of a plurality of layers to form a printed object. Also disclosed herein are methods for dimensionally controlling the diameter of filaments or treating the filaments used in such material extrusion-type of additive manufacturing methods. These dimensionally controlling and treating methods can include controlling the filament diameter by open or closed loop control methods.

Also, as described above, is an optical device for determining a diameter of a filament on an ongoing basis.

A “filament” as used in the present specification and claims refers to any road-like material that can be used in a material extrusion-based system as a feedstock. The filament may be categorized as being round shaped or non-round. shaped. A round shape as used herein means any cross-sectional shape that is enclosed by one or more curved lines. A round shape includes circles, ovals, ellipses, and the like, as well as shapes having an irregular cross-sectional shape. A non-round shape as used herein means any cross-sectional shape enclosed by at least one straight line, optionally together with one or more curved lines. A non-round shape can include squares, rectangles, ribbons, horseshoes, stars, T head shapes, X shapes, chevrons, and the like.

Filaments can be made with materials including polymeric material, waxy material, metal material or composites of several different materials. Thermoplastic polymeric materials that can be used as filaments include polycarbonate, polyetherimide, acrylonitrile-butadiene-styrene, polyphenylene ether, polyphenylene sulfone, polylactic acid, polyamide, polyethylene, polyetheretherketone, polypropylene, polysulfone, polyacrylic, or a combination comprising at least one of the foregoing. If polymeric materials are used as filament materials, the filaments can also include various additives ordinarily incorporated into polymer compositions of this type, with the proviso that any additive is selected so as to not significantly adversely affect the desired properties of the filament. Additives include nucleating agents, fillers, reinforcing agents, antioxidants, heat stabilizers, light stabilizers, ultraviolet (UV) light stabilizers, plasticizers, lubricants, mold release agents, surfactants, antistatic agents, colorants such as titanium dioxide, carbon black, and organic dyes, surface effect additives, radiation stabilizers, flame retardants, and anti-drip agents. A combination of additives can be used, for example a combination of a heat stabilizer and ultraviolet light stabilizer. Additives are used in the amounts generally known to be effective. For example, the total amount of the additives (other than any impact modifier, filler, or reinforcing agents) can be 0.01 to 5 wt. %, based on the total weight of the filament.

The dimensions of a filament as used herein depend upon a variety of parameters, including the shape and dimensions of the feed orifice of the liquefier. In one embodiment, the filament has a circular cross section, in particular, from 1.27 millimeters (0.050 inches) to 3.0 millimeters (0.120 inches) in diameter. See U.S. Pat. Nos. 6,866,807 and 7,122,246 as describing such circular cross section types of filaments having a diameter in the order of 0.069 to 0.074 inches.

Filaments as used herein can be formed by a variety of processes. Examples of such filament forming processes include the steps of mixing, melting and compounding together the various ingredients of the filament, followed by pressurizing and metering the compounded mixture and then extruding the formed filament through an extruder. See the above noted U.S. Pat. Nos. 6,866,807 and 7,122,246 for a description of such filament forming processes. Alternatively, other filament forming processes can be employed.

After being formed, the filament is fed to either the extrusion head before the additive manufacturing process or is spooled onto a supply reel for storage before being fed to the extrusion head. Motor-driven feed rollers can he used to advance the filament toward the extrusion head or the supply reel. Again, see the above noted U.S. Pat. Nos. 6,866,807 and 7,122,246 for a description of such motor-driven feed rollers. Other alternative filament feeding processes or apparatus can be employed herein.

While being fed from the filament forming process to either the extrusion head or spooled onto a supply reel, the moving filament passes through optical device(s) (e.g., 1 to 10 optical devices) that can measure a dimension of the filament (e.g., the diameter of a circular cross sectional filament or the width of a non-round rectangular filament).

Each optical device includes an optical light emitting diode (LED) light source with a wavelength of emitted light between 495 and 570 nanometers to emit light onto the filament; a complementary metal-oxide semiconductor (CMOS) sensor to generate an output value; and a signal processor connected to the CMOS sensor to process the output value from the CMOS sensor. The optical devices having these three elements are sometimes referred to as optical LED micrometers.

The optical LED light source with a wavelength of emitted light between 495 and 570 nanometers (Green LED light) that emits light onto the filament can be any optical LED light source of this wavelength that can illuminate a moving filament with light. In such devices, Green LED light is steadily emitted as a collimated beam. Such Green light LEDs can last longer than traditional LED light sources while providing high intensity and evenly-distributed lightly.

A “CMOS sensor” as used in the present specification and claims refers to any active pixel sensor that uses a complementary metal-oxide semiconductor (CMOS) image technology to determine the outer edge of a dimension of the moving filament. The CMOS sensor detects the position between the light and dark edges of the received light and calculates the measured values.

Each optical device also has a signal processor connected to the CMOS sensor to process the output value from the CMOS sensor. Any suitable signal processor can be used.

Optical devices that include the combination of an optical LED light source with a wavelength of emitted tight between 495 and 570 nanometers with a CMOS sensor and a signal processor as defined herein are more accurate than scanning laser micrometers that have been used before to measure the dimensions of a filament.

Examples of optical LED micrometers that can be used herein include the LS-9000 series high speed optical micrometer available from Keyence Corporation of America of Itasca. Ill., USA.

In one application, from one to 10 rotating optical LED micrometers may be used to more fully measure the dimension of the moving filament.

In some embodiments, the filament can be located between the light source and the sensor, so that the image of the filament is directly projected onto the sensor. In other embodiments, the filament can be located at an offset angle relative to the light source and the sensor, so the light is reflected off the filament and the reflection of the light off the filament is projected. onto the sensor. In still other embodiments, the edge of the filament can be determined by the difference between light and dark areas on the sensor, Dark areas on the CMOS sensor indicate where the filament has blocked the light from the light source. Light areas on the CMOS sensor indicate where the filament has not blocked the light from the light source. The edge of the filament is where a light area is directly next to a dark area on the CMOS sensor. An output value from the sensor can be information about where the edges of the filament are on the CMOS sensor. The signal processor can process the output value or values from the CMOS sensor and determine or calculate the desired dimension of the filament.

While one aspect herein is simply measuring a dimension of the moving filament (such as for quality control purposes), other aspects are drawn to controlling that filament dimension or treating that moving filament after passing through the one to 10 optical LED micrometers.

Controlling a filament dimension can be carried out by, after measuring that dimension along various spots on the moving filament with the optical LED micrometer(s), an electronic control signal can be sent to the apparatus in the filament forming process (e.g., the extruder) or the filament feeding processes or apparatus (e.g., the motor-driven feed rollers) or both, to change that dimension. For example, if that dimension of the moving filament detected to be smaller than expected, an electronic control signal can be sent to the apparatus in the filament forming process (e.g., the extruder) or the filament feeding processes or apparatus (e.g., the motor-driven feed rollers) or both to change that dimension by dispensing more filament from the extruder or increasing the distance between the feed rollers or both. If a portion of the measured dimension on the moving filament is larger than expected, an electronic control signal can be sent to the apparatus in the filament forming process (e.g., the extruder) or the filament feeding processes or apparatus (e.g., the motor-driven feed. rollers) or both to change that dimension by dispensing less filament from the extruder or decreasing the distance between the feed rollers or both. Also, if flat spots or bumps are measured on the filament, these can be quickly and continuously controlled with electronic control signals back to at least one of the filament forming apparatus and the feeding apparatus.

Treating the filament or addressing the problem of a defective filament can also be carried out in conjunction with the above-described measurement. For example, if a circular filament had. a measured flat spot, that flat spot could be marked for later removal or passed through another set of feed rollers or other apparatus to change that flat spot to the desired circular dimension. Likewise, if the moving filament is to be spooled on a supply reel, it may be desirable to place a mark on the filament near the end of the spool that can be optically detected by the operator or operating system that the spool needs to be replaced. In that case, the dimension of the filament being measured is the length of the filament.

The moving filament is then passed through an extrusion head or similar apparatus which melts the moving filament and then passes the melted filament through a dispensing nozzle on the extrusion head. From the dispensing nozzle, the melted filament is deposited as an extruded material strand in a material extrusion-type additive manufacturing process. Examples of average diameters for the extruded material strands can be from 1.27 millimeters (0.050 inches) to 3.0 millimeters (0.120 inches). Depending on the type of a thermoplastic polymeric employed as the filament, the material can be extruded at a temperature of 200 to 450° C. In some embodiments, the thermoplastic polymeric material can be extruded at a temperature of 300 to 415° C. The layers can be deposited at a build temperature (the temperature of deposition of the thermoplastic extruded material) that is 50 to 200° C. lower than the extrusion temperature. For example, the build temperature can be 15 to 250° C. In some embodiments the thermoplastic material is extruded at a temperature of 200 to 450° C., or 300 to 415° C., and the build temperature is maintained at ambient temperature.

A three dimensional article is manufactured by extruding a plurality of layers in a preset pattern by an additive manufacturing. The material extrusion techniques include techniques such as fused deposition modeling and fused filament fabrication as well as others as described in ASTM F2792-12a. Any material extrusion-type additive manufacturing process can be used, provided that the process allows formation of at least two adjacent layers comprising different polymer compositions. In some embodiments, more than two adjacent layers are extruded comprising different polymer compositions. The methods herein can be used for fused deposition modelling (FDM), Big Area Additive Manufacturing (BAAM), ARBURG plastic free forming technology, and other additive manufacturing methods.

In fused material extrusion techniques, an article can be produced by heating a polymer composition to a flowable state that can be deposited to form a layer. The layer can have a predetermined shape in the x-y axis and a predetermined thickness in the z-axis. The flowable material can be deposited as roads as described above, or through a die to provide a specific profile. The layer cools and solidifies as it is deposited. A subsequent layer of melted polymer composition fuses to the previously deposited layer, and solidifies upon a drop in temperature. Extrusion of multiple subsequent layers builds the desired shape.

The total number of layers in the article can vary significantly. Generally but not always, at least 20 layers are present. The maximum number of layers can vary greatly, determined, for example, by considerations such as the size of the article being manufactured, the technique used, the capabilities of the equipment used, and the level of detail desired in the final article. For example, 20 to 100,000 layers can be formed, or 50 to 50,000 layers can be formed. The plurality of layers in the predetermined pattern is fused to provide the article. Any method effective to fuse the plurality of layers during additive manufacturing can be used. In some embodiments, the fusing occurs during formation of each of the layers. In some embodiments the fusing occurs while subsequent layers are formed, or after all layers are formed.

The preset pattern can be determined from a three-dimensional digital representation of the desired article as is known in the art and described in further detail below. In particular, an article can be formed from a three-dimensional digital representation of the article by depositing the flowable material as one or more roads on a substrate in an x-y plane to form the layer. The position of the dispenser (e.g., a nozzle) relative to the substrate is then incremented along a z-axis (perpendicular to the x-y plane), and the process is then repeated to form an article from the digital representation. The dispensed material is thus also referred to as a “modeling material” as well as a “build. material.”

Systems for material extrusion are known. An exemplary material extrusion additive manufacturing system includes a build chamber and a supply source for the polymer composition. The build chamber includes a build platform, a gantry, and a dispenser for dispensing the polymer composition, for example an extrusion head. The build platform is a platform on which the article is built, and desirably moves along a vertical z-axis based on signals provided from a computer-operated controller. The gantry is a guide rail system that can be configured to move the dispenser in a horizontal x-y plane within the build chamber, for example based on signals provided from a controller. The horizontal x-y plane is a plane defined by an x-axis and a y-axis where the x-axis, the y-axis, and the z-axis are orthogonal to each other. Alternatively the platform can be configured to move in the horizontal x-y plane and the extrusion head can be configured to move along the z-axis. Other similar arrangements can also be used such that one or both of the platform and extrusion head are moveable relative to each other. The build platform can be isolated or exposed to atmospheric conditions.

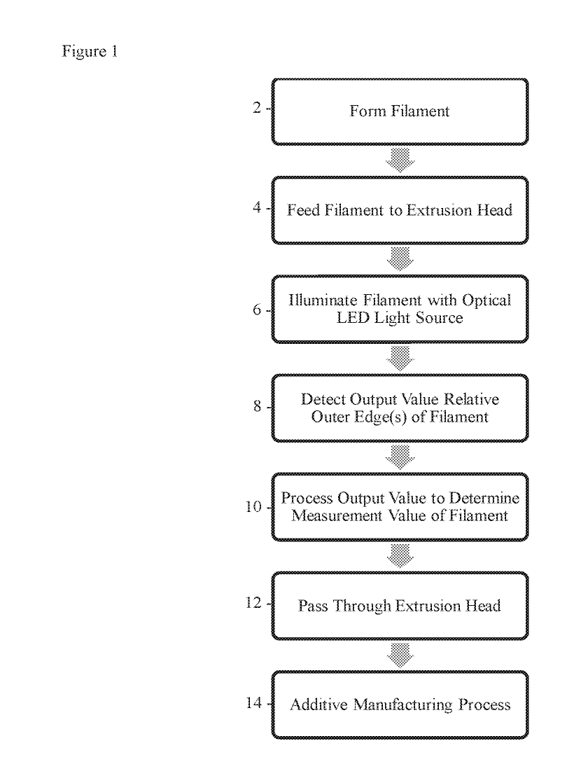

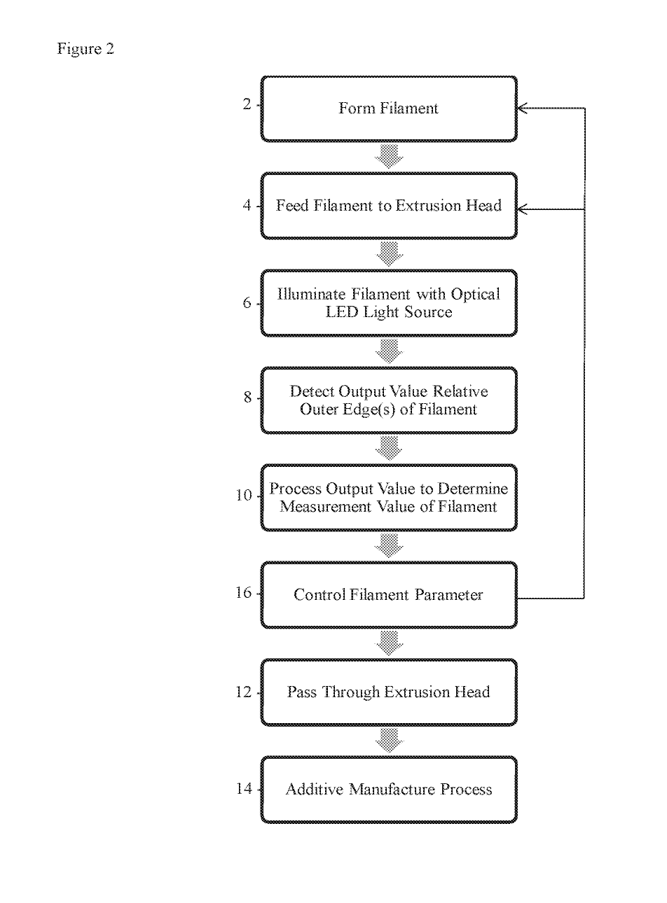

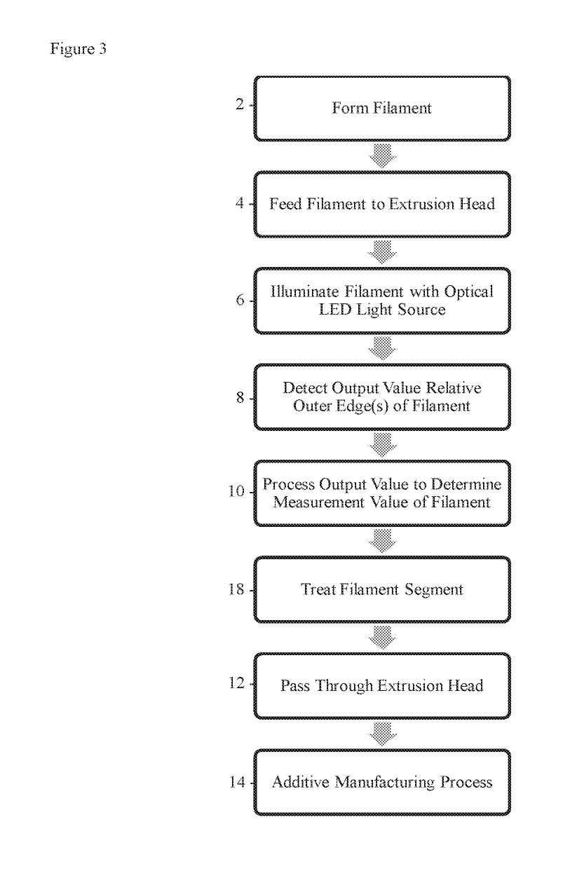

The methods and devices are further illustrated by flow charts in the FIGS. 1-3, which are non-limiting.

The present method is further illustrated by the following Embodiments, which are non-limiting.

Embodiment 1. A method to determine a dimension of a filament in material extrusion additive manufacturing process, the method comprising: illuminating a moving filament with an optical LED light source emitting light with a wavelength between 495 and 570 nanometers; detecting an output value corresponding to an edge of the moving filament at specific points with a CMOS sensor and processing the output value in a signal processor to determine the dimension of the filament at specific points, then passing the filament through an extrusion head, and then depositing a plurality of layers of extruded filament material in a preset pattern and fusing the plurality of layers of extruded filament material to form a three dimensional article.

Embodiment 2. The method of Embodiment 1, wherein the moving filament is positioned between the optical LED light source and the CMOS sensor.

Embodiment 3. The method of either of Embodiments 1 or 2, wherein the output value corresponding to an edge of the filament corresponds to a position of an interface between a lighter area and a darker area on the CMOS sensor.

Embodiment 4. The method of any one or more of the preceding Embodiments, wherein the filament is formed from a polymer comprising polycarbonate, polyetherimide, acrylonitrile-butadiene-styrene, polyphenylene ether, polyphenylene sulfone, polylactic acid, polyamide, polyethylene, polyetheretherketone, polypropylene, polysulfone, polyacrylic, or a combination comprising at least one of the foregoing.

Embodiment 5. The method of any one or more of the preceding Embodiments, wherein the filament dimension s controlled by sending an electronic signal to a filament forming apparatus or a filament feeding apparatus or both to change a processing parameter that changes the filament dimension.

Embodiment 6. The method of Embodiment 5, wherein that dimension of the moving filament is detected to be smaller than expected, and an electronic control signal is sent to the in the filament forming apparatus or the filament feeding apparatus or both to change that filament dimension by dispensing more filament from the filament forming process or increasing the amount of filament passing through the filament feeding apparatus or both.

Embodiment 7, The method of Embodiment 6, wherein that dimension of the moving filament is detected to be larger than expected, and an electronic control signal is sent the in the filament forming apparatus or the filament feeding apparatus or both to change that filament dimension by dispensing less filament from the filament forming process or decreasing the amount of filament passing through the filament feeding apparatus or both.

Embodiment 8. The method of any one or more of the preceding Embodiments, wherein the filament dimension is treated after the filament dimension is measured and before the filament is passed through a extrusion head or spooled on a supply reel.

Embodiment 9. The method of Embodiment 8, wherein the treatment is marking the filament at a point near the end of the filament before spooling on a supply reel.

Embodiment 10. The method of Embodiment 9, wherein the measurement of dimension of the moving filament detected a measured flat spot on a circular filament and the treatment comprised marking the flat spot, passing the portion of the moving filament through a filament feeding apparatus to change that flat spot to the desired circular dimension or both.

Embodiment 11. A filament useful in a material extrusion-type additive manufacturing process, the filament having at least one dimension that has been dimensionally controlled or treated by a process wherein an optical device determines a dimension of the filament, the optical device comprising: an optical LED light source with a wavelength of emitted light between 495 and 570 nanometers to emit light onto the filament; a CMOS sensor to generate an output value; and a signal processor connected to the CMOS sensor to process the output value from the CMOS sensor.

Embodiment 12. The filament of Embodiment 12, wherein the filament is positioned at an offset angle relative to the CMOS sensor.

Embodiment 13. The filament of Embodiments 12 or 13, wherein the filament is positioned between the optical LED light source and CMOS sensor.

The compositions, methods, and articles can alternatively comprise, consist of, or consist essentially of, any appropriate components or steps herein disclosed. The compositions, methods, and articles can additionally, or alternatively, be formulated so as to be devoid, or substantially free, of any steps, components, materials, ingredients, adjuvants, or species that are otherwise not necessary to the achievement of the function and/or objectives of the compositions, methods, and articles.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combination” is inclusive of blends, mixtures, alloys, reaction products, and the like. Furthermore, the terms “first,” “second,” and the like, herein do not denote any order, quantity, or importance, but rather are used to denote one element from another. The terms “a” and “an” and “the” herein do not denote a limitation of quantity, and are to he construed to cover both the singular and the plural, unless otherwise indicated herein or clearly contradicted by context. Reference throughout the specification to “an embodiment”, “another embodiment”, “some embodiments”, and so forth, means that a particular element (e.g., feature, structure, and/or characteristic) described in connection with the embodiment is included in at least one embodiment described herein, and may or may not be present in other embodiments. In addition, it is to be understood that the described, elements may be combined in any suitable manner in the various embodiments.

Unless defined otherwise, technical and scientific terms used herein have the same meaning as is commonly understood by one of skill in the art to which this invention belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

What is claimed is:

1. A method to determine a dimension of a filament in a material extrusion additive manufacturing process, the method comprising:
illuminating a moving filament with an optical LED light source emitting light with a wavelength between 495 and 570 nanometers;
detecting an output value corresponding to an edge of the moving filament at specific points with a CMOS sensor; and
processing the output value in a signal processor to determine the dimension of the filament at specific points, then passing the filament through an extrusion head, and then depositing a plurality of layers of extruded filament material in a preset pattern and fusing the plurality of layers of extruded filament material to form a three dimensional article.

2. The method of claim 1, wherein the moving filament is positioned between the optical LED light source and the CMOS sensor.

3. The method of claim 1, wherein the output value corresponding to an edge of the filament corresponds to a position of an interface between a lighter area and a darker area on the CMOS sensor.

4. The method of claim 1, wherein the filament is formed from a polymer comprising polycarbonate, polyetherimide, acrylonitrile-butadiene-styrene, polyphenylene ether, polyphenylene sulfone, polylactic acid, polyamide, polyethylene, polyetheretherketone, polypropylene, polysulfone, polyacrylic, or a combination comprising at least one of the foregoing.

5. The method of claim 1, wherein the filament dimension is controlled by sending an electronic signal to a filament forming apparatus or a filament feeding apparatus or both to change a processing parameter that changes the filament dimension.

6. The method of claim 5, wherein that dimension of the moving filament is detected to be smaller than expected, and an electronic control signal is sent to the in the filament forming apparatus or the filament feeding apparatus or both to change that filament dimension by dispensing more filament from the filament forming process or increasing the amount of filament passing through the filament feeding apparatus or both.

7. The method of claim 6, wherein that dimension of the moving filament is detected to be larger than expected, and an electronic control signal is sent to the filament forming apparatus or the filament feeding apparatus or both to change that filament dimension by dispensing less filament from the filament forming process or decreasing the amount of filament passing through the filament feeding apparatus or both.

8. The method of claim 1, wherein the filament dimension is treated after the filament dimension is measured and before the filament is passed through a extrusion head or spooled on a supply reel.

9. The method of claim 8, wherein the treatment is marking the filament at a point near the end of the filament before spooling on a supply reel.

10. The method of claim 9, wherein the measurement of dimension of the moving filament detected a measured flat spot on a circular filament and the treatment comprised marking the flat spot, passing the portion of the moving filament through a filament feeding apparatus to change that flat spot to the desired circular dimension or both.

11. A filament useful in a material extrusion-type additive manufacturing process, the filament having at least one dimension that has been dimensionally controlled or treated by a process wherein an optical device determines a dimension of the filament, the optical device comprising:
an optical LED light source with a wavelength of emitted light between 495 and 570 nanometers to emit light onto the filament;
a CMOS sensor to generate an output value; and
a signal processor connected to the CMOS sensor to process the output value from the CMOS sensor.

12. The filament of claim 11, wherein the filament is positioned at an offset angle relative to the CMOS sensor.

13. The filament of claim 11, wherein the filament is positioned between the optical LED light source and CMOS sensor.
